(19) United States
(12) Patent Application Publication
(10) Pub. No.: US 2018/0115974 A1
(43) Pub. Date: Apr. 26, 2018

(54) SYSTEM AND METHOD FOR REDUCTION OF MEDIUM CONTENTION OVER A WIRELESS NETWORK

(71) Applicant: Google Inc., Mountain View, CA (US)

(72) Inventor: Jibing Wang, Saratoga, CA (US)

(21) Appl. No.: 15/298,790

(22) Filed: Oct. 20, 2016

(51) Int. Cl. H04W 72/04; H04L 5/00; H04L 12/26; H04W 76/04; H04W 24/02

(52) U.S. Cl. CPC H04W 72/0453; H04L 5/0055; H04L 69/326; H04W 76/046; H04W 24/02; H04L 43/16

(57) ABSTRACT

Wireless spectral or bandwidth efficiency can be impacted when multiple wireless clients are competing for the medium. The proposed methods and systems use separate frequency band for at least certain uplink and downlink transmissions in response to medium contention. A wireless client device includes a host driver and a first and second wireless channel transceiver configured to communicate on first and second wireless communication channels, respectively. The client device operates in a first or second mode. When the client device operates in the first mode, it transmits transport layer acknowledgement messages for packets received over the first wireless communication channel over the first wireless communication channel using the first wireless channel transceiver. When the client device operates in the second mode, it transmits transport layer acknowledgement messages for packets received over the first communication channel over the second wireless communication channel using the second wireless channel transceiver.

### BACKGROUND

Wireless spectral efficiency may be impacted when multiple wireless clients are competing for the medium.

### SUMMARY

According to one aspect, the subject matter described in this disclosure relates to a wireless client device comprising a host driver, a first wireless channel transceiver configured to communicate on a first wireless communication channel and a second wireless channel transceiver configured to communicate on a second wireless communication channel that is different from the first wireless communication channel. The wireless client device is capable of operating in a first or second mode. The host driver is configured to when the wireless client device is operating in the first mode, transmit over the first wireless communication channel using the first wireless channel transceiver transport layer acknowledgment messages indicating receipt of data packets received over the first wireless communication channel. The host driver is also configured to when the wireless client device is operating in the second mode, transmit over the second wireless communication channel using the second wireless channel transceiver transport layer acknowledgment messages indicating receipt of data packets received over the first wireless communication channel.

According to another aspect, the subject matter described in this disclosure relates to a method that includes operating a wireless client device in a first or second mode. The wireless client device includes a host driver, a first wireless channel transceiver and a second wireless channel transceiver and the first wireless channel transceiver is configured to communicate on a first wireless communication channel and the second wireless channel transceiver is configured to communicate on a second wireless communication channel that is different from the first wireless communication channel. The method further includes transmitting, by the host driver, over a first wireless communication channel using a first wireless channel transceiver, transport layer acknowledgment messages indicating receipt of packets received over the first wireless communication channel, when operating the wireless client device in the first mode and transmitting, by the host driver, over the second wireless communication channel using the second wireless channel transceiver, transport layer acknowledgment messages indicating receipt of packets received over the first wireless communication channel, when operating the wireless client device in the second mode.

According to another aspect, the subject matter described in this disclosure relates to a non-transitory computer readable medium having instructions encoded thereon which, when executed by one or more processors, cause the one or more processors to perform a method that includes operating a wireless client device in a first or second mode. The wireless client device includes a host driver, a first wireless channel transceiver and a second wireless channel transceiver and the first wireless channel transceiver is configured to communicate on a first wireless communication channel and the second wireless channel transceiver is configured to communicate on a second wireless communication channel that is different from the first wireless communication channel. The method includes transmitting, by the host driver, over a first wireless communication channel using a first wireless channel transceiver, transport layer acknowledgment messages indicating receipt of packets received over the first wireless communication channel, when operating the wireless client device in the first mode and transmitting, by the host driver, over the second wireless communication channel using the second wireless channel transceiver transport layer acknowledgment messages indicating receipt of packets received over the first wireless communication channel, when operating the wireless client device in the second mode.

According to another aspect, the subject matter described in this disclosure relates to a system that includes an access point and a wireless client device. The wireless client device includes a host driver, a first wireless channel transceiver configured to communicate on a first wireless communication channel, a second wireless channel transceiver configured to communicate on a second wireless communication channel that is different from the first wireless communication channel. The wireless client device is capable of operating in a first or second mode. The host driver is configured to when the wireless client device is operating in the first mode, transmit over the first wireless communication channel using the first wireless channel transceiver transport layer acknowledgment messages indicating receipt of packets received over the first wireless communication channel and when the wireless client device is operating in the second mode, transmit over the second wireless communication channel using the second wireless channel transceiver transport layer acknowledgment messages indicating receipt of packets received over the first wireless communication channel. The access point is configured to monitor medium access contention on the first wireless communication channel, instruct the client device to operate in the first mode in response to detecting greater than a threshold level of contention on the first wireless communication channel and instruct the client device to operate in the second mode in response to detecting lesser than a threshold level of contention on the first wireless communication channel.

### BRIEF DESCRIPTION OF THE DRAWINGS

The foregoing will be apparent from the following more particular description of example implementations of the invention, as illustrated in the accompanying drawings. The drawings are not necessarily to scale, emphasis instead being placed upon illustrating implementations of the present invention.

FIG. 1 is a diagram of an environment in which separate frequency bands are used in response to medium contention according to an example implementation.

FIG. 2 is a block diagram of a system according to an example implementation.

FIG. 3 is a block diagram of the wireless access point shown in FIG. 2.

FIG. 4 is a block diagram of the client devices shown in FIG. 2.

FIG. 5 is a flow diagram of an example medium contention response method executed by the wireless access point shown in FIGS. 2 and 3.

FIG. 6 is a flow diagram of an example medium contention response method executed by the client devices shown in FIGS. 2 and 4.

FIG. 7 is a flow diagram of an example medium contention response method executed by the client devices shown in FIGS. 2 and 4.

FIG. 8 is a diagram of a computing system suitable for use in the various implementations described.

For purposes of clarity, not every component may be labeled in every figure. The drawings are not intended to be drawn to scale. Like reference numbers and designations in the various figures indicate like elements.

### DETAILED DESCRIPTION

Wireless spectral or bandwidth efficiency can be impacted when multiple wireless clients are competing for the medium. Medium contention can be an issue even in the case of a single wireless access point with multiple client connections operating in a downlink centric environment. While the bulk of the transmitted packets in a downlink centric environment are from the wireless access point to its client connections, some transmitted packets will still be uplink packets. For example, clients acknowledge packets received at the transport layer of the protocol stack by sending transmission control protocol acknowledgement messages (TCP ACKs) to the access point. While the required bandwidth for transmitting uplink TCP ACKs is typically small, multiple clients, each transmitting TCP ACKs to the access point can result in medium contention between the uplink and downlink transmissions. In response to the medium contention, the carrier sense multiple access with collision avoidance (CSMA/CA) protocol's random backoff mechanism can slow down the downlink transmission and impact the wireless network's throughput.

CSMA/CA is one of several Media Access Control (MAC) layer protocols used by various wireless networks to control access to the physical layer or shared medium. MAC protocols generally determine when a node can access the shared medium, resolve conflicts between multiple nodes competing for access to the shared medium and correct communication errors that occur at the physical layer. The CSMA/CA protocol attempts to avoid collisions in the shared medium. Before transmitting a packet, the transmitting node listens to the channel or medium for a pre-specified time period to determine if another node is accessing the channel or medium. If the medium is idle, the node starts transmitting the data packet. If the medium is busy, the node waits for a random time period and at the end of which the node again checks whether the medium is idle. This time period is referred to as the back-off and is counted down using a back-off counter or timer. If the medium is idle when the back-off timer gets to zero, the node transmits the packet. If the medium is busy when the back-off counter gets to zero, the node waits for another back-off time period. This is repeated until the medium becomes idle, at which point the node transmits the packet. Once the packet is received, the receiving node sends back an acknowledgement signal (ACK) within a set time period. If the ACK is not received by the transmitting node within the set time period, it is assumed that the packet is lost and a retransmission is set up. After each unsuccessful transmission the back-off time period or window size is doubled within a contention window range, up to a maximum value. Once the back-off window size reaches a maximum value, it will stay at that value until it is reset. Channel utilization has a significant impact on medium contention. As channel utilization increases, the probability of multiple nodes selecting the same random back-off time period from an initially small contention window range also increases and when multiple nodes select the same back-off time period, they will transmit at the same time resulting in a collision.

To mitigate throughput limitations caused by medium contention, the proposed methods, apparatus, and systems use separate frequency bands for at least certain uplink and downlink transmissions in response to detection of higher levels of medium contention. This division of channel usage can be implemented by taking advantage of dual band dual concurrent (DBDC) communication functionality, which allows signals to be transmitted by a device simultaneously on dual frequency bands such as 2.4 GHz and 5 GHz. Most WI-FI access points currently support DBDC functionality while smart phones and other mobile wireless devices are beginning to support DBDC functionality. A wireless device with DBDC functionality can transmit and receive signals over two communication channels, each corresponding to a different frequency band such as 2.4 GHz and 5 GHz.

An access point and its multiple client connections can transmit uplink and downlink data on a first frequency band, such as the 5 GHz frequency band. In response to medium contention impacting the throughput of the first frequency band, uplink transmission of TCP ACKs can use a second frequency band, such as the 2.4 GHz frequency band, while the first frequency band is reserved for downlink transmission. Medium contention on the second frequency band, such as 2.4 GHz, is less likely even with multiple clients transmitting uplink TCP ACKs due to their typically small bandwidth requirement. In some implementations, uplink data packets can also be transmitted on the 5 GHz frequency band to take advantage of the higher bandwidth of the higher frequency channel. Given the assumed downlink centric environment, the presence of uplink data packets (as opposed to uplink protocol packets such as TCP ACKS) should be less frequent and less likely to negatively impact downlink throughput. In some other implementations, all uplink packets, including both protocol and data packets, are transmitted using the second frequency band.

According to the proposed systems and methods, the use of the 2.4 GHz frequency band for the uplink transmission of TCP ACKs can be dynamically enabled at the client side based on either the client's detection of medium contention on the first frequency band or enabled at the wireless access point side by an instruction sent to the client from the wireless access point. The wireless access point can monitor the medium contention on the first frequency band and in response to detecting medium contention on the first frequency band, the wireless access point can instruct its clients use the second frequency band for uplink transmission of TCP ACKs.

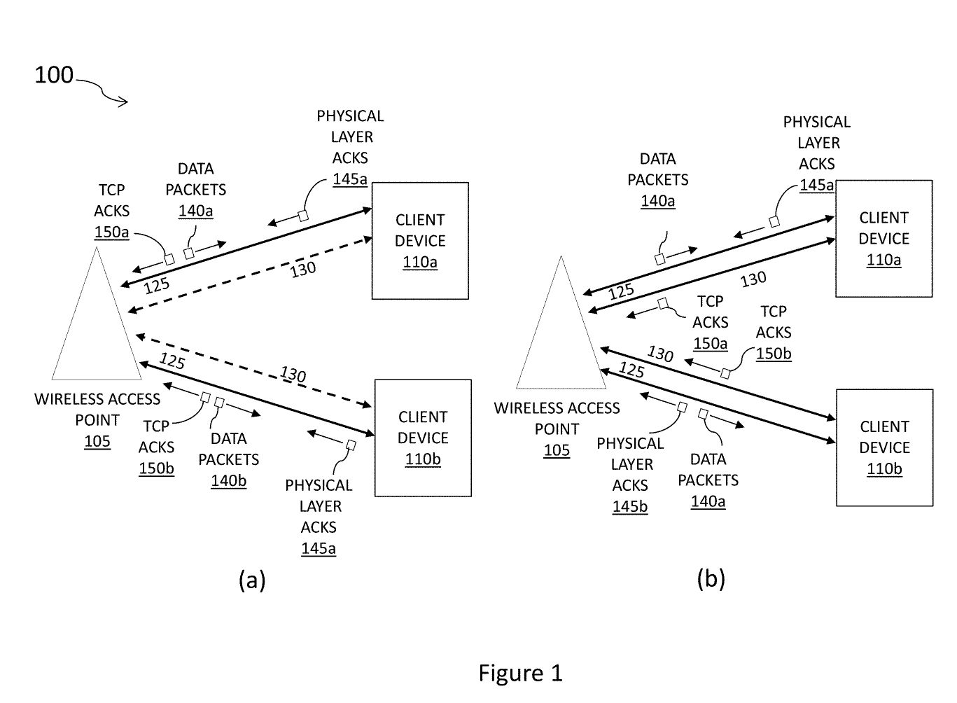

FIG. 1 is a diagram of an environment 100 according to an example implementation. The environment 100 includes a wireless access point 105 and one or more wireless client devices such as a first client device 110a and second client device 110b (generally referred to as the clients 110). In some implementations, the client devices 110 can be wireless devices such as smartphones, laptops, tablets, etc. that are mobile or stationary. In some implementations, the wireless access point 105 can be a WI-FI access point such as a wireless router, switch or hot spot. In some implementations, the wireless access point 105 and the client devices 210 are configured to communicate using one or more of the 802.11 protocols, including without limitation the 802.11, 802.11a, 802.11b, 802.11g, 802.11n and 802.11c protocols. In FIG. 1, the wireless access point 105 and the client devices 110 are configured to transmit and receive on a first wireless communication channel 125 and a second wireless communication channel 130 that is different from the first wireless communication channel 125. In some implementations, the first wireless communication channel 125 is associated with a first frequency band and the second wireless communication channel 130 is associated with a second frequency band that is different from the first frequency band. In some implementations, the first frequency band is higher than the second frequency band.

FIG. 1 shows downlink transmissions including data packets 140a and 140b (generally referred to as downlink data packets 140) transmitted by the wireless access point 105 to the client devices 110. FIG. 1 also shows uplink transmissions including the transport layer acknowledgement messages 150a and 150b (generally referred to as the TCP ACKs 150) and physical layer acknowledgement messages 145a and 145b (generally referred to as the physical layer ACKs 145) transmitted by the client devices 110 to the wireless access point 105 for corresponding downlink data packets 140 received by the client devices 110.

In FIG. 1(a), the client devices 110 operate in a first mode and in FIG. 1(b), in response to detecting medium contention in the first communication channel 125, the client devices 110 operate in a second mode. In FIG. 1(a), the wireless access point 105 and the client devices 110 share the first wireless communication channel 125 for both the uplink and downlink transmissions (indicated by a solid bidirectional arrow between the wireless access point 105 and the client devices 110) while the second wireless communication channel 130 is not used for uplink or downlink transmission (indicated by a dashed bidirectional arrow between the wireless access point 105 and the client devices 110). FIG. 1(a) shows that even in a downlink centric environment where the bulk of the packet transmission is from the wireless access point 105 to the client devices 110, the TCP ACKs 150, when transmitted by each of the multiple client devices 110 to the wireless access point 105 can result in medium contention between the uplink and downlink transmissions over the first wireless communication channel 125.

In FIG. 1(b), in response to detecting medium contention on the first communication channel 125, the client devices 110 operate in a second mode. The wireless access point 105 transmits the downlink data packets 140 on the first wireless communication channel 125. The client devices 110 transmit physical layer ACKs 150 for corresponding received downlink data packets 140 back over the first wireless communication channel 125, as time is explicitly reserved in the time windows allocated to a data packet transmission for the transmission physical layer ACKS in most wireless protocols. Most wireless protocols are acknowledgement based with the receiving node acknowledging receipt of packets. After transmitting a packet, the transmitting node expects to receive an acknowledgment message within a window of time after the packet is transmitted. If the transmitting node does not receive an acknowledgement from the receiving node within the acknowledgment window, it re-transmits the packet. The acknowledgment window is specified according to the data link protocol in use. Upon receiving the downlink packets, the client devices 110 transmit physical layer ACKs 150 for the corresponding received downlink data packets 140 back over the first wireless communication channel 125.

The client devices 110 also transmit the TCP ACKs 150 but on the second wireless communication channel 130. In contrast to the physical layer ACKs 145, which are scheduled to be received by the wireless access point within the acknowledgment window, the TCP ACKs 150 are not scheduled to be received by the access point 105 within a time period. According to the TCP ACK protocol, the receiving node sends the transmitting node a data transmission window size that informs the transmitting node how much data the receiving node is willing to accept from the transmitting node. The transmitting node can send the amount of data specified by the data transmission window, after which, the transmitting node waits for acknowledgements from the receiving node for the received data. Therefore, in contrast to physical layer ACKs 145, which are explicitly scheduled for as part of a physical layer data packet transmission, TCP ACKs 150 are transmitted at times that are not scheduled by the wireless access point 105. Thus, while the transmission of the physical layer ACKs 145 are not likely to result in medium contention, the transmission of TCP ACKs 150 may result in medium contention. Accordingly, upon detection of a level of medium contention that is greater than a threshold level of medium contention, the client devices 210 transmit the TCP ACKs 150 over the second wireless channel 130, thereby reducing the likelihood of contention on the first wireless channel 125. Medium contention on the second wireless communication channel 130 is not likely even with multiple clients 110 transmitting the uplink TCP ACKs 150 due to the typically small bandwidth required by the TCP ACKs 150. FIG. 1(b) shows that even in a downlink centric environment, multiple client devices 110 transmitting the TCP ACKs 150 to the wireless access point 105 on the second wireless communication channel 130 will likely not result in medium contention in the second wireless communication channel 125 due to the small bandwidth required by the TCP ACKs 150.

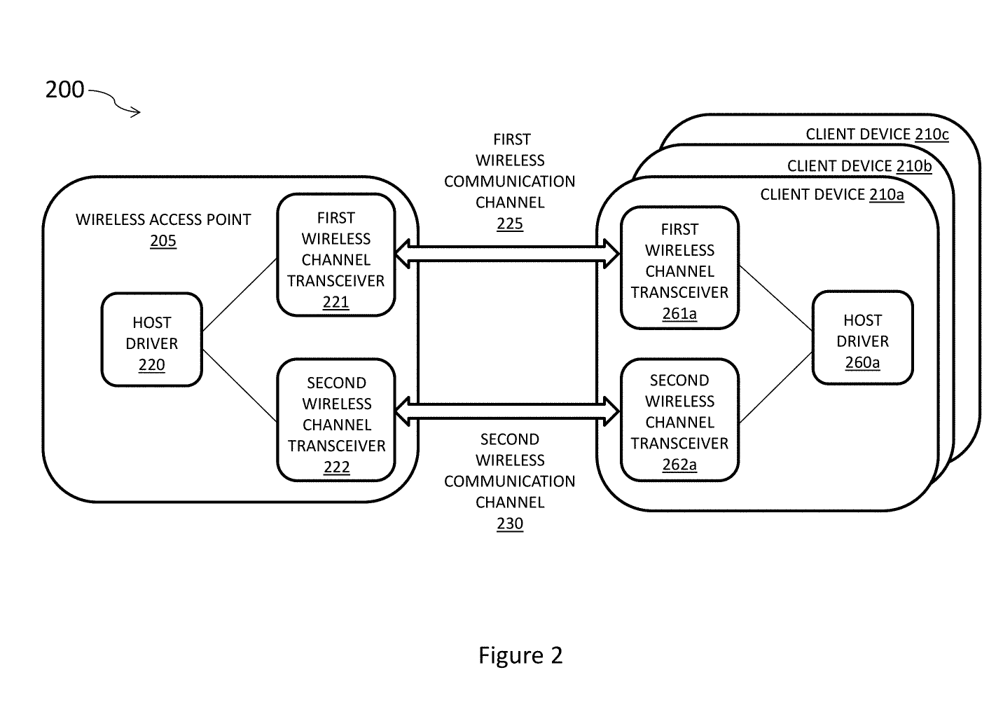

FIG. 2 is a block diagram of a system according to an example implementation. The system 200 includes a wireless access point 205, such as the wireless access point 105 shown in FIG. 1 and one or more wireless client devices such as a first client device 210a, a second client device 210b and a third client device 210c (generally referred to as the client devices 210), also shown in FIG. 1 as the client devices 110. In broad overview, the wireless access point 205 and the client devices 210 share the first wireless communication channel 225 for both the uplink and downlink transmission, and in response to detecting a level of contention in the first wireless communication channel 225, the client devices 210 transmit at least a portion of their uplink traffic using the second wireless communication channel 230. In some implementations, the first wireless communication channel 225 can be associated with a first frequency band and the second wireless communication channel 230 can be associated with a second frequency band that is different from the first frequency band. In some implementations, the first wireless communication channel 225 is associated with a first frequency band and the second wireless communication channel is associated with a second frequency band that is different from the first frequency band. In some implementations, the first frequency band is 5 GHz and the second frequency band is 2.4 GHz. In some implementations, the wireless client devices 210 are capable of dual band dual concurrent transmission.

As indicated above, the system 200 includes a wireless access point 205. For example, the wireless access point 205 can be a WI-FI access point configured to communicate using one or more of the 802.11 protocols, including without limitation the 802.11, 802.11a, 802.11b, 802.11g, 802.11n and 802.11c protocols. The wireless access point 205 is configured to transmit and receive data over the first wireless communication channel 225 and the second wireless communication channel 230. To that end, the wireless access point 205 includes a host driver 220, a first wireless channel transceiver 221 and a second wireless channel transceiver 222. Each transceiver includes a transmitter and a receiver. In some implementations, the transmitter and receiver may be combined to share common circuitry. The host driver 220 is configured to transmit and receive over the first wireless communication channel 225 using the first wireless channel transceiver 221 and transmit and receive over the second wireless communication channel 230 using the second wireless channel transceiver 222.

As indicated above, the system 200 includes multiple client devices 210. In some implementations, the client devices 110 can be wireless devices such as smartphones, laptops, tablets, etc. that are mobile or stationary. For example, the client devices 210 can be configured to communicate using one or more of the 802.11 protocols, including without limitation the 802.11, 802.11a, 802.11b, 802.11g, 802.11n and 802.11c protocols. The client devices 210 are configured to transmit data to and received data using the first wireless communication channel 225 and the second wireless communication channel 230. To that end, each of the client devices 210 includes a host driver, such as the host drivers 260a-260c (generally referred to as the client host drivers 260), a first wireless channel transceiver, such as the first wireless channel transceivers 261a-261c (generally referred to as the first wireless channel transceivers 261) and a second wireless channel transceiver, such as the second wireless channel transceivers 262a-262c (generally referred to as the second wireless channel transceivers 262). As described above, each transceiver can include a combined transmitter and receiver sharing common circuitry. The host drivers 260 are configured to transmit and receive over the first wireless communication channel 225 using the first wireless channel transceivers 261 and transmit and receive over the second wireless communication channel 230 using the second wireless transceivers 262.

In FIG. 2, the host drivers 260 of the wireless client devices 210 are further configured to operate the client devices 210 in a first or second mode. When the host drivers 260 operate their respective client devices 210 in the first mode, the client devices 210 transmit data packets over the first wireless communication channel 225 using the first wireless channel transceivers 261. The client devices 210 also transmit control messages, such as physical layer ACKs, such as the physical layer ACKs 145, and TCP ACKs, such as the TCP ACKs 150, shown in FIG. 1, indicating receipt of the data packets received over the first wireless communication channel 225. When the host drivers 260 operate the client devices 210 in the second mode, the host drivers 260 transmit at least a portion of their network traffic over the second wireless communication channel 230 using the second wireless channel transceivers 261. For example, the host drivers transmit certain protocol packets, such as the TCP ACKs 150 indicating receipt of the data packets received over the first wireless communication channel 225. The physical layer ACKs, such as the physical layer ACKS 145 shown in FIG. 1, are transmitted over the first wireless communication channel 225 when the client devices are operating in the second mode. In some implementations, when operating in the second mode, the host drivers 260 cause their respective clients to transmit all traffic, other than physical layer ACKs 145 over the second wireless communication channel 230.

The client devices 210 operate in a first or second mode in response to detecting greater or lesser than a threshold level of medium contention on the first wireless communication channel 225. In some implementations, the host drivers 260 are configured to operate the client devices 210 in the first mode or the second mode in response to the detection of a level of medium contention on the first wireless communication channel 225. In some other implementations, the host driver 220 of the wireless access point 205 is configured to monitor the medium access contention on the first wireless communication channel 225 and instruct the client devices 210 to operate in a first or second mode in response to detecting greater or lesser than a threshold level of contention on the first wireless communication channel 225. In some implementations, a level of medium contention on the first communication channel 225 can be determined based on monitoring one or more indicators of medium contention such as the rate of collision (i.e. re-transmission of data packets or missing ACKs), channel utilization, back-off window size and back-off time periods. A threshold level of medium contention may be determined based on acceptable values for these indicators of medium contention.

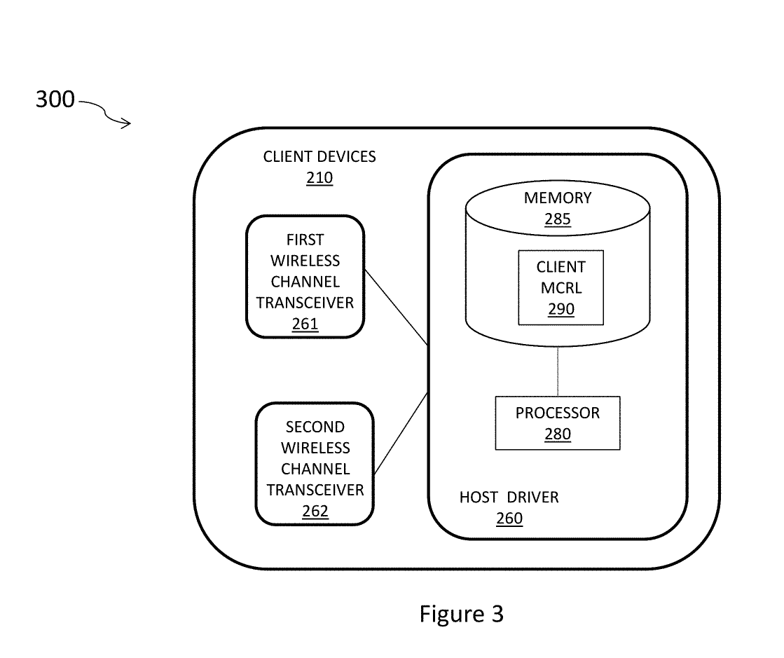

FIG. 3 is a block diagram 300 of the wireless access point 205 shown in FIG. 2. In some implementations, the wireless access point 105 can be a WI-FI access point such as a wireless router, switch or hot spot, configured to communicate using one or more of the 802.11 protocols, including without limitation the 802.11, 802.11a, 802.11b, 802.11g, 802.11n and 802.11c protocols. In FIG. 3, the host driver 220 of the wireless access point 205 is configured to monitor the medium access contention on the first wireless communication channel 225 and instruct the client devices 210 to operate in a first or second mode in response to detecting greater or lesser than a threshold level of contention on the first wireless communication channel 225. To that end, the host driver 220 further includes a processor 281, a memory 286 and a wireless access point medium contention response logic (WAP MCRL) 291 that provides medium access response functionality. In some implementations, the WAP MCRL 291 can be computer executable instructions, stored in non-transitory computer readable media, such as the computer memory 286, which are executed by a general or special purpose processor such as the processor 281.

The WAP MCRL 291 selects a first mode or second mode of operation based on the level of medium contention detected on the first wireless communication channel 225 and the threshold level of medium contention. In some implementations, detection of the level of medium contention on the first communication channel 225 may be based on one or more indicators of medium contention such as the rate of collision (i.e. re-transmission of data packets or missing ACKs), channel utilization, contention window sizing and back-off timer values. A threshold level of medium contention may also be based on one or more of these indicators of medium contention. In some implementations, a contention window size greater than 200 microseconds may be indicative of an increased level of medium contention in the communication channel. The WAP MCRL 291 selects a first mode of operation if the detected level of medium contention on the first wireless communication channel 225 is below the threshold level of medium access contention. In response to the WAP MCRL 291 selecting the first mode of operation, the host driver 220 instructs the client devices 210 to operate in the first mode. Upon receiving the instruction to operate in the first mode, the client devices 210 transmit over the first wireless communication channel 225 using the first wireless channel transceivers 221, the TCP ACKs 150 and the physical layer ACKs 145, shown in FIG. 1, indicating receipt of the data packets received over the first wireless communication channel 225. The WAP MCRL 291 selects a second mode of operation if the detected level of medium contention on the first wireless communication channel 225 is above the threshold level of medium access contention. In some implementations, the WAP MCRL 291 can select a second mode of operation in response to detecting a contention window size in the first wireless communication channel 225 that is greater than a threshold level of 200 microseconds. In response to the WAP MCRL 291 selecting the second mode of operation, the host driver 220 instructs the client devices 210 to operate in the second mode. Upon receiving the instruction to operate in the second mode, the client devices 210 transmit over the second wireless communication channel 230 using the second wireless channel transceivers 261, the TCP ACKs 150 and the physical layer ACKs 145, shown in FIG. 1, indicating receipt of the data packets received over the first wireless communication channel 225.

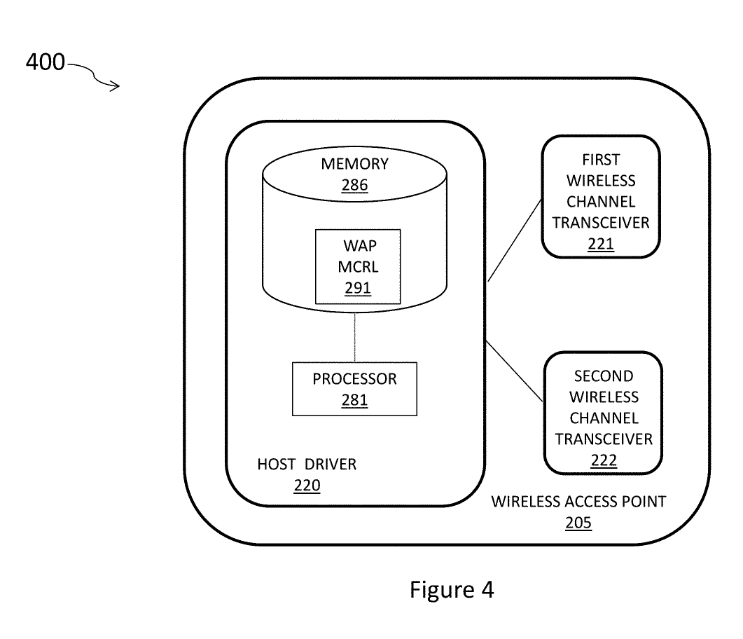

FIG. 4 is a block diagram 400 of the client devices 210 shown in FIG. 2. In some implementations, the client devices 110 can be wireless devices such as smartphones, laptops, tablets, etc. that are mobile or stationary. In some implementations, the client devices 210 are configured to communicate using one or more of the 802.11 protocols, including without limitation the 802.11, 802.11a, 802.11b, 802.11g, 802.11n and 802.11c protocols. In FIG. 2, the host drivers 260 of the client devices 210 are configured to operate the client devices 210 in the first mode or the second mode in response to the detection of a level of medium contention on the first wireless communication channel 225. To that end, the host drivers 260 further include a processor 280, a memory 285 and a client medium contention response logic (Client MCRL) 290 that provides medium contention response functionality. In some implementations, the Client MCRL 290 can be computer executable instructions, stored in non-transitory computer readable media, such as the computer memory 285, which are executed by a general or special purpose processor such as the processor 280.

The Client MCRL 290 selects a first mode or second mode of operation based on the level of medium contention detected on the first wireless communication channel 225 and the threshold level of medium contention. In some implementations, detection of the level of medium contention on the first communication channel 225 may be based on one or more indicators of medium contention such as the rate of collision (i.e. re-transmission of data packets or missing ACKs), channel utilization, contention window sizing and back-off timer values. A threshold level of medium contention may also be based on one or more of these indicators of medium contention. In some implementations, a contention window size greater than 200 microseconds may be indicative of an increased level of medium contention in the communication channel. The Client MCRL 290 selects a first mode of operation if the detected level of medium contention on the first wireless communication channel 225 is below the threshold level of medium access contention. In response to the Client MCRL 290 selecting the first mode of operation, the host drivers 260 operate the client devices 210 in the first mode and transmit over the first wireless communication channel 230 using the first wireless channel transceivers 261, the TCP ACKs 150 and the physical layer ACKs 145, shown in FIG. 1, indicating receipt of the data packets received over the first wireless communication channel 225. The Client MCRL 290 selects a second mode of operation if the detected level of medium contention on the first wireless communication channel 225 is above the threshold level of medium access contention. In some implementations, the Client MCRL 290 can select a second mode of operation if the contention window size in the first wireless communication channel 225 is above a threshold level of 200 microseconds. In response to the Client MCRL 290 selecting the second mode of operation, the host drivers 260 operate the client devices 210 in the second mode and transmit TCP ACKs 150 over the second wireless communication channel 230 using the second wireless channel transceivers 261, indicating receipt of the data packets received over the first wireless communication channel 225. Physical layer ACKs are still transmitted over the first wireless communication channel 225. In some implementations, in the second mode of operation, the host drivers 260 also cause their respective client devices to transmit other communications packets including uplink data packets and control protocol packets over the second wireless communication channel 230 using their second wireless transceivers 262. In some implementations, the host drivers 260 can also operate the client devices 210 in the first or second mode in response receiving an instruction from the wireless access point 205.

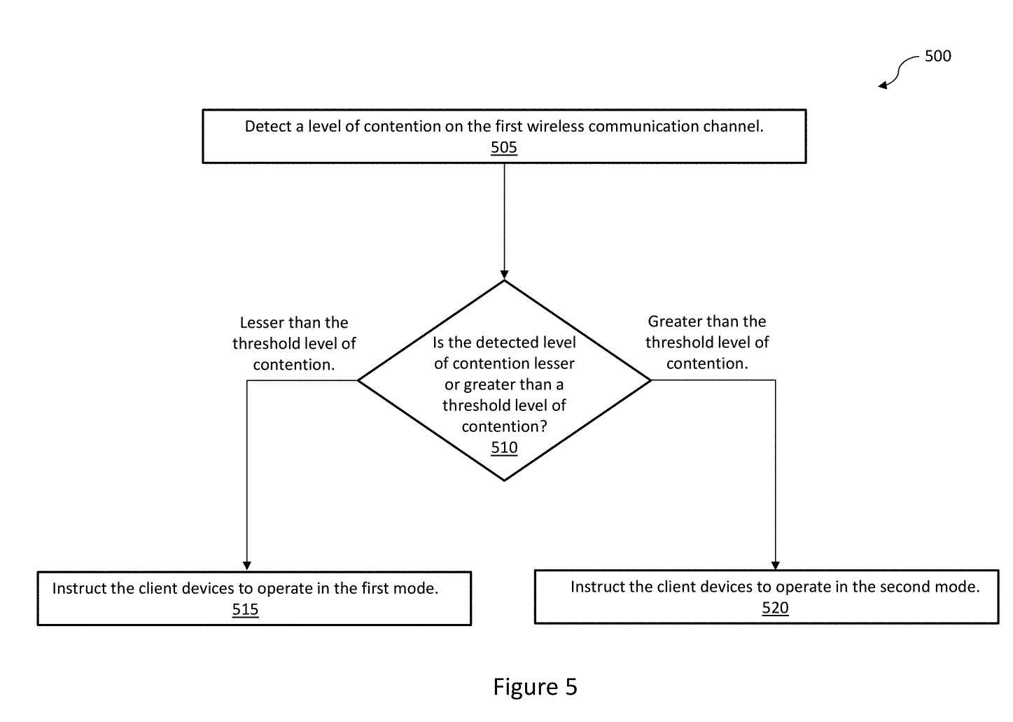

FIG. 5 is a flow diagram of an example medium contention response method 500 executed by the wireless access point 205 (referred to as “the WAP medium contention response method”) shown in FIGS. 2 and 3. The medium contention response method 500 includes detecting a level of medium contention on the first wireless communication channel (stage 505), determining whether the detected level of contention is lesser or greater than a threshold level of medium contention (stage 510) and instructing the client devices to operate in a first mode (stage 515) or a second mode (stage 520).

The WAP medium contention response method 500 includes detecting a level of medium contention on the first wireless communication channel (stage 505). The WAP MCRL 291 of the host driver 220 of the wireless access point 205 can monitor and detect a level of medium contention on the first wireless communication channel 225. In some implementations, detection of the level of medium contention on the first communication channel 225 may be based on one or more indicators of medium contention such as the rate of collision (i.e. re-transmission of data packets or missing ACKs), channel utilization, contention window sizing and back-off timer values. In some implementations, a contention window size greater than 200 microseconds may be indicative of an increased level of medium contention in the communication channel. The WAP medium contention response method 500 includes determining whether the detected level of contention is lesser or greater than a threshold level of medium contention (stage 510). A threshold level of medium contention may also be based on one or more of the indicators of medium contention described above.

The WAP medium contention response method 500 includes instructing the client devices 110 to operate in a first mode (stage 515) or a second mode (stage 520). The WAP MCRL 291 of the wireless access point 205 causes the host driver 220 of the wireless access point 205 to send instructions to the client devices 210 to operate in a first mode in response to detecting lesser than a threshold level of contention on the first wireless communication channel 225 and instructions to the client devices 210 to operate in a second mode in response to detecting greater than a threshold level of contention on the first wireless communication channel 225. In some implementations, the WAP MCRL 291 of the wireless access point 205 may cause the host driver 220 of the wireless access point 205 to send instructions to the client devices 210 to operate in a second mode in response to detecting that the contention window size in the first wireless communication channel 225 is greater than a threshold level of 200 microseconds.

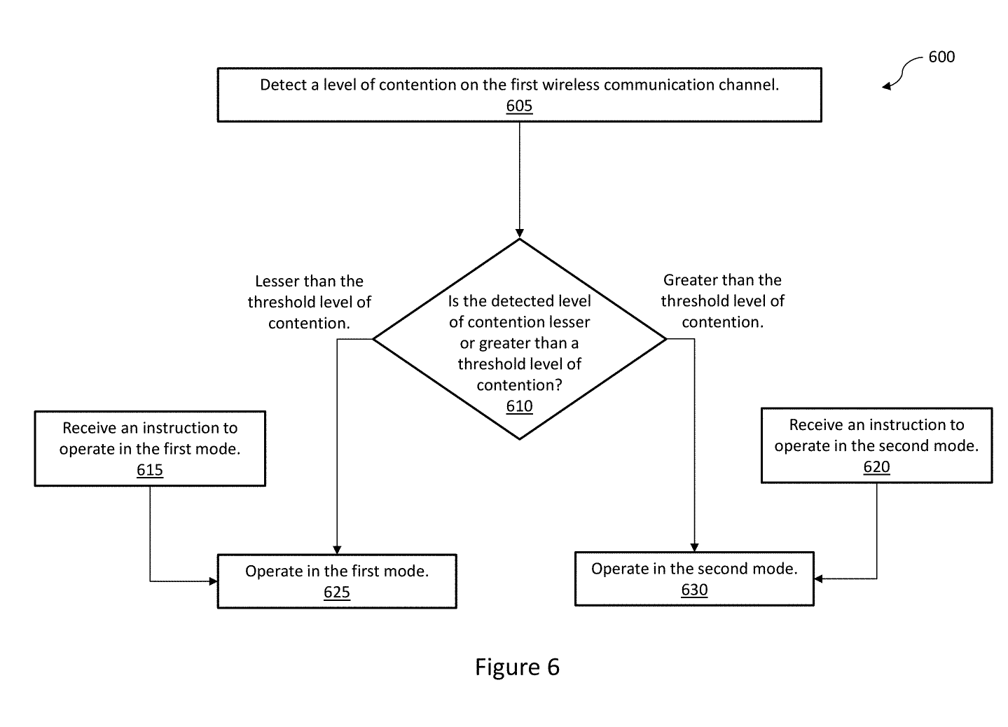

FIG. 6 is a flow diagram of an example medium contention response method 600 executed by the client devices 210 (referred to as “the client medium contention response method 600”) shown in FIGS. 2 and 3. The client medium contention response method 600 includes detecting a level of medium contention on the first wireless communication channel (stage 605), determining whether the detected level of medium contention is greater than or lesser than a threshold level of medium contention (stage 610), operating in a first mode if the detected level of medium contention is lesser than a threshold level of medium contention (stage 625) or upon receiving an instruction to operate in a first mode (stage 615) and operating a second mode if the detected level of medium contention is greater than a threshold level of medium contention (630) or upon receiving an instruction to operate in a second mode (stage 620).

The Client MCRL 290 is configured to detect a level of medium contention in the first communication channel 225. In some implementations, a level of medium contention on the first communication channel 225 can be determined based on monitoring one or more indicators of medium contention such as the rate of collision (i.e. re-transmission of data packets or missing ACKs), channel utilization, back-off window size and back-off time periods. A threshold level of medium contention may be determined based on acceptable values for these indicators of medium contention. In some implementations, a contention window size greater than 200 microseconds may be indicative of an increased level of medium contention in the communication channel. The Client MCRL 290 selects a first mode of operation if the detected level of medium contention on the first wireless communication channel 225 is below a threshold level of medium access contention and selects a second mode of operation if the detected level of medium contention on the first wireless communication channel 225 is above the threshold level of medium access contention. In some implementations, regardless of the detected level of medium contention, the Client MCRL 290 causes the host driver 260 of the client device 210 to operate in a mode included in an instruction received from a WAP MCRL 291.

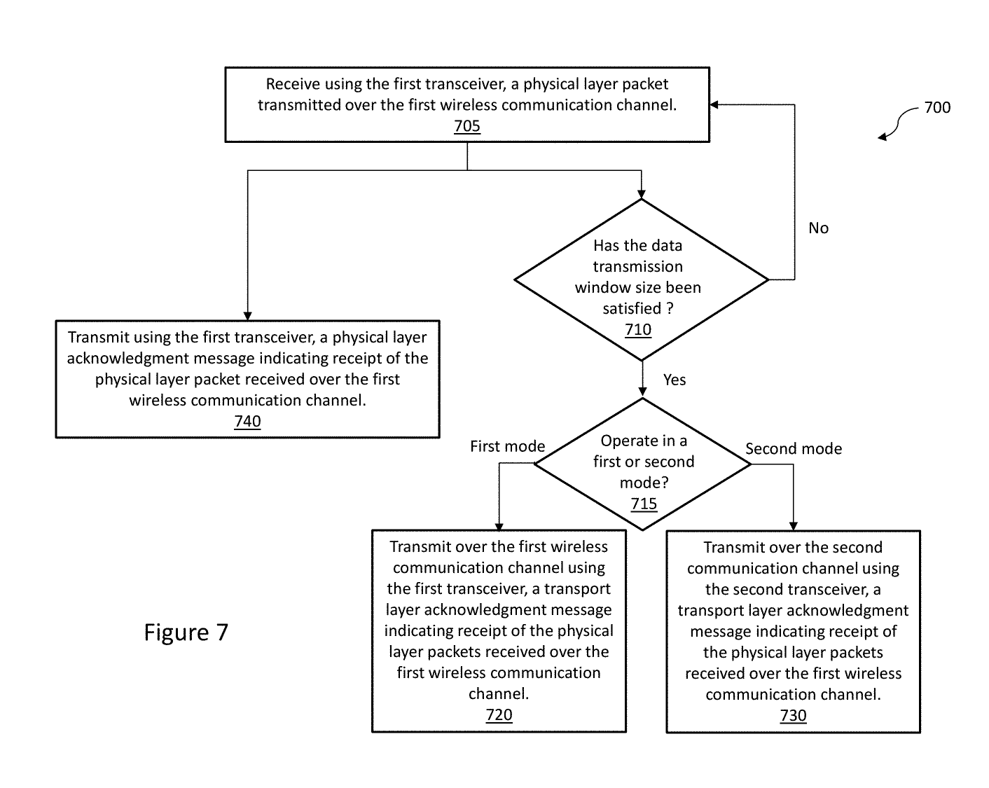

FIG. 7 is a flow diagram of an example medium contention response method 700 executed by the client devices 210 (referred to as “the client medium contention response method 700”) shown in FIGS. 2 and 3. The client medium contention response method 700 includes receiving using the first transceiver, a physical layer packet transmitted over the first wireless communication channel (stage 705), transmitting using the first transceiver, a physical layer acknowledgment message indicating receipt of the physical layer packet received over the first wireless communication channel (stage 740), determining whether the data transmission window size has been satisfied (stage 710), and determining whether the client devices are to operate in a first or second mode (stage 715). If operating in a first mode, the method 700 includes transmitting over the first wireless communication channel using the first transceiver, a transport layer acknowledgment message indicating receipt of the packets received over the first wireless communication channel (stage 720). If operating in a second mode, the method 700 includes transmitting over the second wireless communication channel using the second transceiver, a transport layer acknowledgment message indicating receipt of the packets received over the first wireless communication channel (stage 730).

As shown in FIG. 1, upon receiving the downlink packets, the client devices 110 transmit physical layer ACKs 150 for the corresponding received downlink data packets 140 back over the first wireless communication channel 125. Upon receiving the downlink packets, the client devices 110 also transmit the TCP ACKs 150. In contrast to the physical layer ACKs 145, the TCP ACKs 150 are not transmitted by the client devices 110 until the amount of data received from the access point 105 is close to that specified by the data transmission window size. When the client devices 210 operate in the first mode, the client devices 210 transmit over the first wireless communication channel 225 using the first wireless channel transceivers 261, the TCP ACKs 150 indicating receipt of the data packets received over the first wireless communication channel 225. When the client devices 210 operate in the second mode, the client devices 210 transmit over the second wireless communication channel 225 using the second wireless channel transceivers 261, the TCP ACKs 150 indicating receipt of the data packets received over the first wireless communication channel 225.

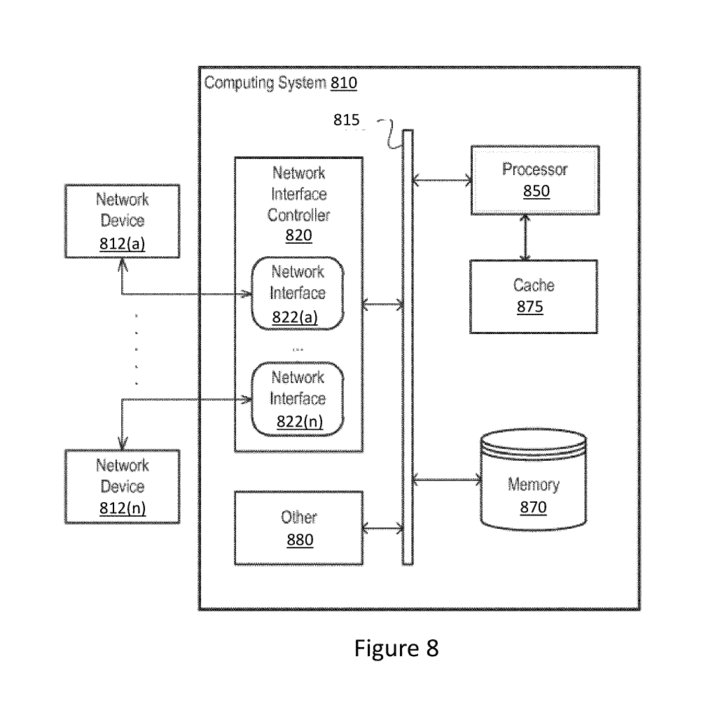

FIG. 8 shows a block diagram of an example computing system 810. In some implementations, the computing system 810 may be utilized in implementing the methods 500, 600 and 700 in FIGS. 3-7.

In broad overview, the computing system 810 includes at least one processor 850 for performing actions in accordance with instructions and one or more memory devices 870 or 875 for storing instructions and data. The illustrated example computing system 810 includes one or more processors 850 in communication, via a bus 815, with at least one network interface controller 820 with network interface ports 822(a-n) connecting to other computing devices 812(a-n), memory 870, and any other devices 880, e.g., an I/O interface. Generally, a processor 850 will execute instructions received from memory. The processor 850 illustrated incorporates, or is directly connected to, cache memory 875.

In more detail, the processor 850 may be any logic circuitry that processes instructions, e.g., instructions fetched from the memory 870 or cache 875. In many embodiments, the processor 850 is a microprocessor unit or special purpose processor. The computing device 810 may be based on any processor, or set of processors, capable of operating as described herein. In some implementations, the processor 850 can be capable of executing the methods 500, 600 and 700 shown in FIGS. 5-7. The processor 850 may be a single core or multi-core processor. The processor 850 may be multiple processors. In some implementations, the processor 850 can be configured to run multi-threaded operations. In some implementations, the processor 850 may host one or more virtual machines or containers, along with a hypervisor or container manager for managing the operation of the virtual machines or containers. In such implementations, one or more of the methods 500, 600 and 700 shown in FIGS. 5-7 can be implemented within the virtualized or containerized environments provided on the processor 850.

The memory 870 may be any device suitable for storing computer readable data. The memory 870 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, and BluRay® discs). A computing system 810 may have any number of memory devices 870. In some implementations, the memory 870 can include instructions corresponding to the methods 500, 600 and 700 shown in FIGS. 5-7. In some implementations, the memory 870 supports virtualized or containerized memory accessible by virtual machine or container execution environments provided by the computing system 810.

The cache memory 875 is generally a form of computer memory placed in close proximity to the processor 850 for fast read times. In some implementations, the cache memory 875 is part of, or on the same chip as, the processor 850. In some implementations, there are multiple levels of cache 875, e.g., L2 and L3 cache layers.

The network interface controller 820 manages data exchanges via the network interfaces 822(a-n) (also referred to as network interface ports). The network interface controller 820 handles the physical and data link layers of the OSI model for network communication. In some implementations, some of the network interface controller's tasks are handled by the processor 850. In some implementations, the network interface controller 820 is part of the processor 850. In some implementations, a computing system 810 has multiple network interface controllers 820. The network interfaces 822(a-n) are connection points for physical network links. In some implementations, the network interface controller 820 supports wireless network connections and an interface port 822 is a wireless receiver/transmitter. Generally, a computing device 810 exchanges data with other computing devices 812(a-n) via physical or wireless links to a network interfaces 822(a-n). In some implementations, the network interface controller 820 implements a network protocol such as Ethernet.

The other computing devices 812(a-n) are connected to the computing device 810 via a network interface port 822. The other computing devices 812(a-n) may be peer computing devices, network devices, or any other computing device with network functionality. For example, a first computing device 812(a) may be a network device such as a hub, a bridge, a switch, or a router, connecting the computing device 810 to a data network such as the Internet.

The other devices 880 may include an I/O interface, external serial device ports, and any additional co-processors. For example, a computing system 810 may include an interface (e.g., a universal serial bus (USB) interface) for connecting input devices (e.g., a keyboard, microphone, mouse, or other pointing device), output devices (e.g., video display, speaker, or printer), or additional memory devices (e.g., portable flash drive or external media drive). In some implementations, a computing device 810 includes an additional device 880 such as a coprocessor, e.g., a math co-processor can assist the processor 850 with high precision or complex calculations.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

The operations described in this specification can be implemented as operations performed by a data processing apparatus on data stored on one or more computer-readable storage devices or received from other sources. The operations may be executed within the native environment of the data processing apparatus or within one or more virtual machines or containers hosted by the data processing apparatus.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers or one or more virtual machines or containers that are located at one site or distributed across multiple sites and interconnected by a communication network. Examples of communication networks include a local area network (“LAN”) and a wide area network (“WAN”), an inter-network (e.g., the Internet), and peer-to-peer networks (e.g., ad hoc peer-to-peer networks).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A wireless client device comprising:
a host driver;
a first wireless channel transceiver configured to communicate on a first wireless communication channel; and
a second wireless channel transceiver configured to communicate on a second wireless communication channel that is different from the first wireless communication channel;
wherein the wireless client device is capable of operating in a first or second mode and the host driver is configured to:
when the wireless client device is operating in the first mode, transmit over the first wireless communication channel using the first wireless channel transceiver transport layer acknowledgment messages indicating receipt of data packets received over the first wireless communication channel; and
when the wireless client device is operating in the second mode, transmit over the second wireless communication channel using the second wireless channel transceiver transport layer acknowledgment messages indicating receipt of data packets received over the first wireless communication channel.

2. The wireless client device of claim 1, wherein the host driver is further configured to:
operate the wireless client device in the first mode in response to the detection by the wireless client device of a level of medium access contention on the first wireless communication channel that is less than a threshold level of medium access contention; and
operate the wireless client device in the second mode in response to the detection of a level of medium access contention on the first wireless communication channel that is greater than the threshold level of medium access contention.

3. The wireless client device of claim 1, wherein the first wireless communication channel is associated with a first frequency band and the second wireless communication channel is associated with a second frequency band that is different from the first frequency band.

4. The wireless client device of claim 3, wherein the first frequency band is 5 GHz and the second frequency band is 2.4 GHz.

5. The wireless client device of claim 1, wherein the wireless client device is capable of dual band dual concurrent communication.

6. The wireless client device of claim 1, wherein the host driver is configured to transmit data packets over the first wireless communication channel when the wireless client device is operating in the first mode and transmit data packets over the second wireless communication channel when the wireless client device is operating in the second mode.

7. The wireless client device of claim 1, wherein the host driver is configured to operate the wireless client device in the first mode upon receiving an instruction to operate the wireless client device in the first mode and is configured to operate the wireless client device in the second mode upon receiving an instruction to operate in the wireless client device in the second mode.

8. A method comprising:
operating a wireless client device in a first or second mode, wherein the wireless client device comprises a host driver, a first wireless channel transceiver and a second wireless channel transceiver and the first wireless channel transceiver is configured to communicate on a first wireless communication channel and the second wireless channel transceiver is configured to communicate on a second wireless communication channel that is different from the first wireless communication channel;
transmitting, by the host driver, over a first wireless communication channel using a first wireless channel transceiver, transport layer acknowledgment messages indicating receipt of packets received over the first wireless communication channel, when operating the wireless client device in the first mode;
transmitting, by the host driver, over the second wireless communication channel using the second wireless channel transceiver, transport layer acknowledgment messages indicating receipt of packets received over the first wireless communication channel, when operating the wireless client device in the second mode

9. The method of claim 8, wherein the first wireless communication channel is associated with a first frequency band and the second wireless communication channel is associated with a second frequency band that is different from the first frequency band.

10. The method of claim 9, wherein the first frequency band is 5 GHz and the second frequency band is 2.4 GHz.

11. The method of claim 8, wherein the wireless client device is capable of dual band dual concurrent communication.

12. The method of claim 8, the method further comprising:
transmitting, by the client device, data packets over the first wireless communication channel when the wireless client device is operating in the first mode and transmitting, by the client device, data packets over the second wireless communication channel when the wireless client device is operating in the second mode.

13. The method of claim 8, operating the wireless client device in the first mode upon receiving an instruction, by the host driver, to operate the wireless client device in the first mode and is configured to operate the wireless client device in the second mode upon receiving an instruction, by the host driver, to operate in the wireless client device in the second mode.

14. A non-transitory computer readable medium having instructions encoded thereon which, when executed by one or more processors, cause the one or more processors to perform a method, the method comprising:
operating a wireless client device in a first or second mode, wherein the wireless client device comprises a host driver, a first wireless channel transceiver and a second wireless channel transceiver and the first wireless channel transceiver is configured to communicate on a first wireless communication channel and the second wireless channel transceiver is configured to communicate on a second wireless communication channel that is different from the first wireless communication channel;
transmitting, by the host driver, over a first wireless communication channel using a first wireless channel transceiver, transport layer acknowledgment messages indicating receipt of packets received over the first wireless communication channel, when operating the wireless client device in the first mode;
transmitting, by the host driver, over the second wireless communication channel using the second wireless channel transceiver transport layer acknowledgment messages indicating receipt of packets received over the first wireless communication channel, when operating the wireless client device in the second mode.

15. The non-transitory computer-readable medium of claim 14, wherein the first wireless communication channel is associated with a first frequency band and the second wireless communication channel is associated with a second frequency band that is different from the first frequency band.

16. The non-transitory computer-readable medium of claim 15, wherein the first frequency band is 5 GHz and the second frequency band is 2.4 GHz.

17. The non-transitory computer-readable medium of claim 14, wherein the wireless client device is capable of dual band dual concurrent communication.

18. The non-transitory computer-readable medium of claim 14, wherein the method further comprises:
transmitting data packets over the first wireless communication channel when the wireless client device is operating in the first mode and transmitting data packets over the second wireless communication channel when the wireless client device is operating in the second mode.

19. The non-transitory computer-readable medium of claim 14, wherein the method further comprises:
operating the wireless client device in the first mode upon receiving an instruction, by the host driver, to operate the wireless client device in the first mode and is configured to operate the wireless client device in the second mode upon receiving an instruction, by the host driver, to operate in the wireless client device in the second mode.

20. A system comprising:
an access point;
a wireless client device comprising:
a host driver;
a first wireless channel transceiver configured to communicate on a first wireless communication channel;
a second wireless channel transceiver configured to communicate on a second wireless communication channel that is different from the first wireless communication channel;
wherein the wireless client device is capable of operating in a first or second mode and the host driver is configured to:
when the wireless client device is operating in the first mode, transmit over the first wireless communication channel using the first wireless channel transceiver transport layer acknowledgment messages indicating receipt of packets received over the first wireless communication channel; and
when the wireless client device is operating in the second mode, transmit over the second wireless communication channel using the second wireless channel transceiver transport layer acknowledgment messages indicating receipt of packets received over the first wireless communication channel;
the access point configured to:
monitor medium access contention on the first wireless communication channel;
instruct the client device to operate in the first mode in response to detecting greater than a threshold level of contention on the first wireless communication channel; and
instruct the client device to operate in the second mode in response to detecting lesser than a threshold level of contention on the first wireless communication channel.

21. The system of claim 20, wherein the first wireless communication channel is associated with a first frequency band and the second wireless communication channel is associated with a second frequency band that is different from the first frequency band.

22. The system of claim 21, wherein the first frequency band is 5 GHz and the second frequency band is 2.4 GHz.

23. The system of claim 20, wherein the wireless client device is capable of dual band dual concurrent communication.

24. The system of claim 20, wherein the wireless device transmits data packets on the first wireless communication channel when operating in the first mode and transmits data packets on the second wireless communication channel when operating in the second mode.
